(19) United States
(12) Patent Application Publication
(10) Pub. No.: US 2008/0136829 A1
(43) Pub. Date: Jun. 12, 2008

(54) GPU CONTEXT SWITCHING SYSTEM

(75) Inventor: Chien-Fu Su, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/832,104

(22) Filed: Aug. 1, 2007

(30) Foreign Application Priority Data
Dec. 11, 2006 (TW) 95146226

(51) Int. Cl. G06F 13/14

(52) U.S. Cl. 345/520

(57) ABSTRACT

A graphics processing unit (GPU) context switching system is provided. The GPU renders digital 3D images based on register values therein. A video random access memory (VRAM) temporarily stores the images before the images are output to a display. A driver controls the GPU. Upon receiving a first request for rendering an image from a first application, the driver generates register values corresponding to the first application according to the first request and writes the register values to the registers of the GPU. Upon receiving a second request for rendering an image from another application, the GPU stores the register values as a first backup in the VRAM.

### BACKGROUND OF THE INVENTION

1. Field of the Invention

The invention relates to computer techniques, and more particularly to a graphics processing unit (GPU) context switching system.

2. Description of the Related Art

A graphics processing unit (GPU) is designed to render 2-dimensional and 3-dimensional images. In a computer, when an application requests resources of a GPU, the driver thereof receives the request and accordingly computes register values required by the GPU and writes the register values to the GPU. The GPU renders desired images based on entire register values corresponding to the application. The last version of GPU register values, referred to as the chip image, is maintained by the driver. For example, in FIG. 1, driver 134 maintains chip image 136 for application 131. In response to different image rendering requests from the same application 131, rather than updating the entire chip image, only a portion of the register values in chip image 136 requiring update according to respective image rendering requests is calculated and transmitted to register 122 in GPU 120.

In a multitasking operating system environment, when different applications (such as applications 131-133) are competing for resources of GPU 120, driver 134 generates and transmits full versions of chip images to GPU 120 for each currently served application occupying resources of GPU 120. A chip image typically comprises a great data amount, thus, transmission of chip images from driver 134 to GPU 120 consumes excessive channel bandwidth between driver 134 and GPU 120 (of course including the bandwidth between buses 140, 142, and Northbridge 112 too). The problem of excessive bandwidth consumption becomes more severe as the number of competing applications increases.

### BRIEF SUMMARY OF THE INVENTION

Graphics processing unit (GPU) context switching systems are provided. An exemplary embodiment of a graphics processing unit (GPU) context switching system comprises a GPU, a video random access memory (VRAM), and a driver. The GPU renders digital 3D images based on register values therein. The VRAM temporarily stores the images before the images are output to a display. The driver controls the GPU. Upon receiving a first request for rendering an image from a first application, the driver generates register values corresponding to the first application according to the first request and writes the register values to the registers of the GPU. Upon receiving a second request for rendering an image from a second application different from the first application, the GPU stores the register values as a first backup in the VRAM.

An exemplary embodiment of a graphics processing unit (GPU) context switching system comprises a GPU, a video random access memory (VRAM), and a driver. The GPU comprises a first register set and a second register set. The first register set is the active register set. The GPU renders at least one digital image based on register values of the active register set. The VRAM temporarily stores the image before the image is output to a display. The driver controls the GPU. Upon receiving a first request for rendering at least one image from a first application, the driver generates register values corresponding to the first application in response to the first request and writes the register values to the first register set, and upon receiving a second request for rendering at least one image from a second application different from the first application, assigns the second register set as the active register set, thus the register values of the first register set as a first backup therein are preserved.

An exemplary embodiment of a graphics processing unit (GPU) context switching system comprises a GPU, a video random access memory (VRAM), and a driver. The GPU comprises a plurality of registers and renders a digital image based on register values of the registers. The VRAM temporarily stores the image before the image is output to a display. The driver controls the GPU, and directs the GPU to store a first backup of the register values of the registers in the VRAM.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a conventional computer;

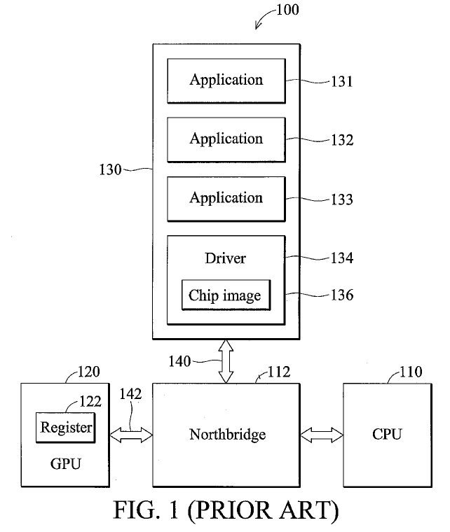

FIG. 2 is a block diagram showing the configuration of an exemplary embodiment of a GPU context switching system;

FIG. 3 is a flowchart showing exemplary operations of the system;

FIG. 4 is a block diagram showing the configuration of another exemplary embodiment of a GPU context switching system;

FIG. 5 is a flowchart showing exemplary operations of the system;

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

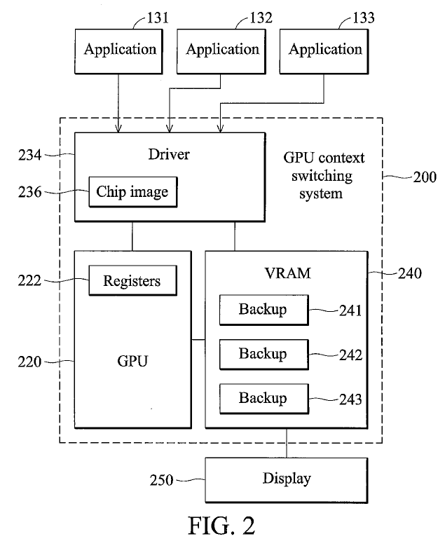

With reference to FIG. 2, an exemplary embodiment of a GPU context switching system 200 is provided, comprising GPU 220, video random access memory (VRAM) 240, and driver 234.

GPU 220 can render 2D and/or 3D digital images. Driver 234 for driving GPU 220 may be implemented by one or more computer programs. GPU 220 may comprise a plurality of registers 222 and render digital images based on register values of registers 222. VRAM 240 temporarily stores the digital images before the images are output to display 250.

Typically, VRAM 240 and GPU 220 may be located in a display adapter. Note that GPU 220 can store values of registers 222 in VRAM 240 and/or load the register values from VRAM 240. Driver 234 may allocate memory areas for storing the register values and locate memory addresses from which the register values are loaded to registers 222.

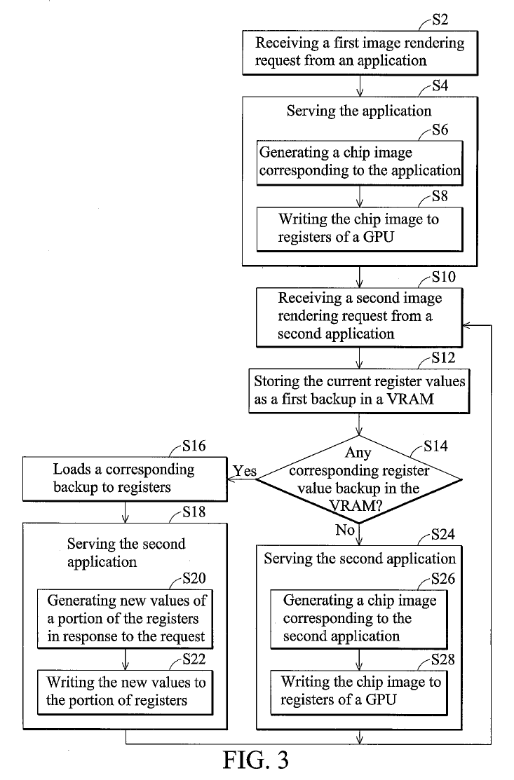

With reference to FIG. 3, exemplary operations of the GPU context switching system 200 are provided.

Driver 234 initially serves no application. Upon receiving a first request for rendering at least one image from application 131 (step S2), driver 234 begins serving application 131 (step S4). Driver 234 drives GPU 220 to render images according to requests for application 131. In step S4, driver 234 generates a full version of register values, i.e. the values of all registers 222, as chip image 236 corresponding to application 131 in response to the first request (step S6), and drives GPU 220 by writing the register values to registers 222 of GPU 220 (step S8). Writing new values to all registers 222 is referred to as a full update, and writing new values to a portion of registers 222 is referred to as a partial update. At this time, driver 234 and GPU 220 serve application 131 for the first time, thus step S8 is a full update.

Upon receiving a second request for rendering at least one image from another application (such as application 132) (step S10), the driver 234 directs GPU 220 to store the current register values as a first backup in VRAM 240 (such as backup 241 corresponding to application 131 in FIG. 2) (step S12). For example, when driver 234 receives a second request for rendering at least one image from application 132, GPU 220 stores a full version of the current register values which both corresponds to application 131 as backup 241 in VRAM 240. Backup 241 corresponds to application 131.

Driver 234 determines if VRAM 240 comprises a backup corresponding to the application delivering the second image rendering request (step S14). If so, driver 234 loads the corresponding backup of the application to registers 222 (step S16). If not, step S24 is directly performed to serve the application.

At this time, the driver 234 serves application 132 for the first time, thus, VRAM 240 has no corresponding backup thereof, and driver 234 directly performs step S24 to serve application 132. In step S24, driver 234 generates a full version of the values of all registers 222, as chip image 236 corresponding to application 132 in response to image rendering requests for application 132 (step S26), and drives GPU 220 by writing chip image 236 to registers 222 of GPU 220 (step S28). At this time, driver 234 and GPU 220 serve application 132 for the first time, thus the writing step S28 is a full update.

If necessary, driver 234 may back up values of registers 222 corresponding to application 132. Upon receiving a third request for rendering at least one image from another application (step S10), driver 234 directs the GPU 220 to store the current values of registers 222 as backup 242 in VRAM 240 corresponding to application 132 (step S12). Backups 241 and 242 can be chip images which are not coded.

If the application delivering the third image rendering request comprises application 131, driver 234 determines that its corresponding backup 241 has been stored in VRAM 240, thus, backup 241 is located in VRAM 240 and backup 241 is restored to registers 222 (step S16). In other words, driver 234 directs GPU 220 to retrieve register values corresponding to application 131 from backup 241 and write the retrieved register values to registers 222 of GPU 220.

Because GPU 220 has retrieved register values corresponding to application 131 from VRAM 240, driver 234 can directly perform step S18 without fully updating registers 222 for application 131. Upon receiving the third request, driver 234 serves the application delivering the third image rendering request (step S18), generates new register values of a portion of registers 222 in response to the third request (step S20) and writes the new register values to the portion of registers 222 (step S22). Thus, channel bandwidth occupied between driver 234 and GPU 220 is reduced.

Upon receiving a fourth request for rendering at least one image from another application, driver 234 directs GPU 220 to store the current register values corresponding to application 131 as backup 243 in VRAM 240. Driver 234 may overwrite backup 241 by backup 243 or directly delete backup 241.

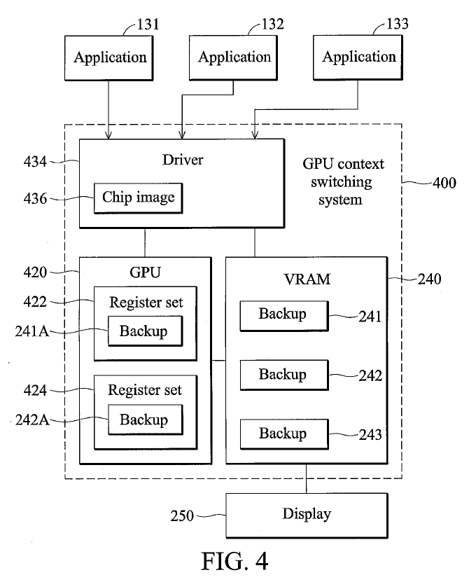

With reference to FIG. 4, an exemplary embodiment of a GPU context switching system 400 is provided, comprising GPU 420, video random access memory (VRAM) 240, and driver 434. Except for new details described in the following, entities in this embodiment are analogous to like entities in previously described embodiments. Driver 434 in FIG. 4 drives GPU 420. GPU 420 may comprise register sets 422 and 424, one of which is the active register set. GPU 420 initially utilizes register set 422 as the active register set and can render digital images based on register values in the active register set. VRAM 240 temporarily stores the digital images before the images are output to a display.

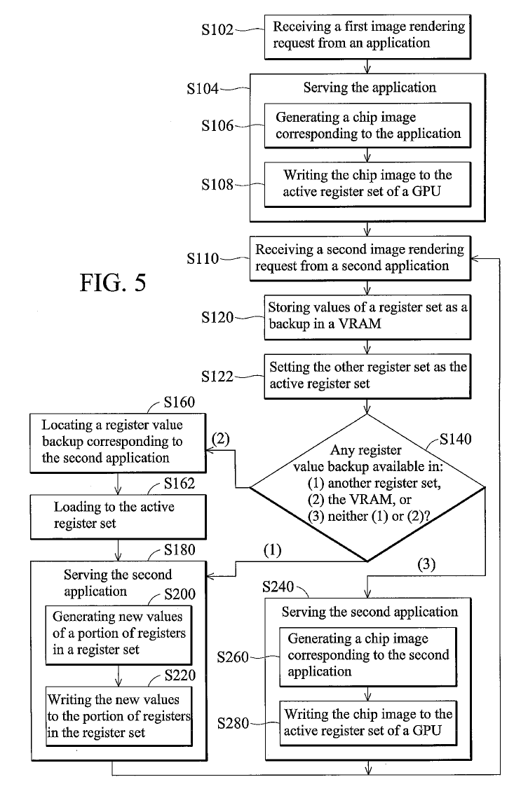

With reference to FIG. 5, driver 434 initially serves no application. Upon receiving a first request for rendering at least one image from application 131 (step S102), driver 434 begins to serve application 131 (step S104), comprising generating a full version of register values as chip image 436 corresponding to application 131 in response to the first request (step S106), and writing the register values (i.e. chip image 436) to the active register set of GPU 420, currently the register set 422 (step S108).

Upon receiving a second request for rendering at least one image from a second application (such as application 132) (step S110), the driver 434 directs GPU 420 to store a backup of the current values of register set 422 in VRAM 240 (step S120) and assigns the remaining register set (such as register set 424) as the active register set (step S122). Thus, the last register values are reserved in register set 422. Accordingly, the corresponding register values of the last executed application may be reserved in one of the register sets. Register values in register set 422 are preserved in backup 241A. Backups 241 and 241A both correspond to application 131.

Driver 434 determines (step S140) if a corresponding register value backup of the application delivering the second image rendering request is stored in (1) another register set (such as register set 424), (2) VRAM 240, or (3) neither (1) or (2). In case (1), wherein a corresponding register value backup is stored in another register set (such as register set 424), because in step S122 the GPU 420 has assigned the other register set (such as register set 424) as the active register set, in step S180 image rendering may be directly performed according the register values therein.

In case (2), wherein a corresponding register value backup is stored in VRAM 240, driver 434 locates the backup (step S160), loads the corresponding backup of the application to the active register sets (such as register set 424) (step S162). In case (3), where no corresponding register value backup is available, driver 434 directly performs step S240.

At this time driver 434 serves application 132 for the first time, thus, register set 424 and VRAM 240 have no corresponding backup thereof, and driver 434 directly performs step S240 to serve application 132. In step S240, driver 434 generates a full version of values of all registers in register set 424, as chip image 436 corresponding to application 132 in response to image rendering requests for application 132 (step S260), and writes chip image 436 to register set 424 of GPU 420 (step S280). At this time driver 434 and GPU 420 serve application 132 for the first time, thus the writing step S280 is a full update.

If necessary, driver 434 may back up register values in register set 424 corresponding to application 132. For example, upon receiving a third request for rendering at least one image from another application (step S110), driver 434 directs the GPU 420 to store the current register values in register set 424 as backup 242 in VRAM 240 corresponding to application 132 (step S120) and assign the other register set (such as register set 424) as the active register set (step S122). Thus, the current register values are preserved in backup 242A in register set 424.

If the application delivering the third image rendering request is application 131, driver 434 determines that its corresponding register value backups have been stored in register set 422 and VRAM 240 (step S140). Because register set 422 comprises backup 241A, step S180 may be directly performed to serve the application without loading backup 241 from VRAM 240.

Because GPU 420 has retrieved register values corresponding to application 131 from register set 422, driver 434 does not require a full update of register set 422 for application 131. Upon receiving the third request, driver 234 generates new register values of a portion of registers in register set 422 in response to the third request (step S200) and writes the new register values to the portion of registers in register set 422 (step S220). Thus, channel bandwidth occupied between driver 434 and GPU 420 is reduced.

Because application 132 is the last served application, the corresponding register values are reserved in register set 424. GPU 420 must have the capability of switching the active register set. Note that a GPU may comprise more register sets as cache memories for storing backups of register values. If so, the driver of the GPU may reserve a backup of register values corresponding to an application. When resuming serving of the application, the driver determines the register set reserving the backup and assigns the register set as the active register set.

In conclusion, in the GPU context switching system of the invention, a GPU can store register values for a corresponding application in a VRAM. When serving of the application resumes, the register values may be restored from the VRAM. A GPU may comprise a plurality of register sets, one of which is the active set while others serve as cache memory for storing register value backups.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded to the broadest interpretation so as to encompass all such modifications and similar arrangements.

What is claimed is:

1. A graphics processing unit (GPU) context switching system, comprising:
a GPU comprising a plurality of registers and rendering a digital image based on register values of the registers;
a video random access memory (VRAM) temporarily storing the digital image before the digital image is output to a display; and
a driver controlling the GPU, and upon receiving a first request for rendering at least one image from a first application, generating the register values corresponding to the first application in response to the first request and writing the register values to the registers of the GPU, wherein upon receiving a second request for rendering at least one image from a second application different from the first application, the driver directs the GPU to store the register values as a first backup in the VRAM.

2. The system as claimed in claim 1, wherein, upon receiving the second request from the second application, the driver generates register values corresponding to the second application in response to the second request and writes the register values to the registers of the GPU, and upon receiving a third request for rendering at least one image from a third application different from the second application, the driver directs the GPU to store the register values as a second backup in the VRAM.

3. The system as claimed in claim 2, wherein, when the third application is the first application, the driver locates the first backup in the VRAM and directs the GPU to retrieve register values corresponding the first application from the first backup and write the retrieved register values to the registers of the GPU.

4. The system as claimed in claim 3, wherein, upon receiving the third request, the driver generates new register values of a portion of the registers in response to the third request and writes the new register values to the portion of the registers of the GPU.

5. The system as claimed in claim 4, wherein, upon directing the GPU to store the register values corresponding to the first application as a third backup in the VRAM, the driver deletes the first backup.

6. A graphics processing unit (GPU) context switching system, comprising:
a GPU comprising a first register set and a second register set, where the first register set is the active register set, and the GPU renders at least one digital image based on register values of the active register set;
a video random access memory (VRAM) temporarily storing the digital image before the digital image is output to a display; and
a driver for controlling the GPU, wherein upon receiving a first request for rendering at least one image from a first application, the driver generates register values corresponding to the first application in response to the first request and writes the register values to the first register set, and upon receiving a second request for rendering at least one image from a second application different from the first application, assigns the second register set as the active register set, thus to reserve the register values of the first register set as a first backup therein.

7. The system as claimed in claim 6, wherein, upon receiving the second request from the second application, the driver further directs the GPU to store the register values of the first register set as the second backup in the VRAM.

8. The system as claimed in claim 7, wherein the driver generates register values corresponding to the second application in response to the second request and writes the register values to the second register set of the GPU, and the GPU renders at least one digital image based on register values of the second register set.

9. The system as claimed in claim 8, wherein, upon receiving a third request from the first application different from the first application, the driver further determines if the first register set comprises the first backup corresponding to the first application, and if so, sets the first register set as the active register set.

10. The system as claimed in claim 9, wherein the driver generates new register values of a portion of the first register set in response to the third request and writes the new register values to the portion of the first register set of the GPU, and the GPU renders at least one digital image based on register values of the first register set.

11. The system as claimed in claim 9, wherein when the first register set does not comprise the first backup, the driver sets the first register set as the active register set, retrieves and loads the second backup from the VRAM to the first register set.

12. A graphics processing unit (GPU) context switching system, comprising:
a GPU comprising a plurality of registers and rendering a digital image based on register values of the registers;
a video random access memory (VRAM) temporarily storing the digital image before the digital image is output to a display; and
a driver controlling the GPU, and directing the GPU to store a first backup of the register values of the registers in the VRAM.

13. The system as claimed in claim 12, wherein the driver restores the first backup to the registers of the GPU.

14. The system as claimed in claim 13, wherein, when the driver suspends serving a first application, the GPU stores the first backup in the VRAM.

15. The system as claimed in claim 14, wherein, when the driver resumes serving the first application, the GPU restores the first backup from the VRAM to the registers.

16. The system as claimed in claim 15, wherein, after the GPU restores the first backup from the VRAM to the registers the driver updates a portion of register values in the registers in response to an image rendering request of the first application and writes the new register values to the portion of the registers of the GPU.

17. The system as claimed in claim 13, wherein the GPU further comprises a cache memory to which the driver directs the GPU to store a second backup of register values of the registers.

18. The system as claimed in claim 17, wherein the driver restores the second backup to the registers of the GPU.

19. The system as claimed in claim 18, wherein, when the driver suspends serving a first application, the GPU stores the first backup in the VRAM and the second backup in the cache memory.

20. The system as claimed in claim 19, wherein, when resuming serving the first application, the driver determines if the cache memory comprises the second backup, if so, restores the second backup to the registers of the GPU, and if not, retrieves and restores the first backup from the VRAM to the registers.
